(19) United States
(12) Patent Application Publication
(10) Pub. No.: US 2009/0015835 A1
(43) Pub. Date: Jan. 15, 2009

(54) METHOD OF ANALYZING A PAINT FILM WITH EFFECT PIGMENTS

(75) Inventors: Aneeshkumar Balakrishnan, Kottayam (IN); Prashant Raman, Bangalore (IN); Gerardus Johannes Petrus Van Den Kieboom, Leiderdorp (NL)

Correspondence Address: KENYON & KENYON LLP, ONE BROADWAY, NEW YORK, NY, 10004, US

(73) Assignee: AKZO NOBEL COATINGS INTERNATIONAL B.V., ARNHEM (NL)

(21) Appl. No.: 12/279,934

(22) PCT Filed: Feb. 22, 2007
(86) PCT No.: PCT/EP2007/051700

§ 371 Date: Sep. 29, 2008

Related U.S. Application Data
(60) Provisional application No. 60/791,443, filed on Apr. 13, 2006.

(30) Foreign Application Priority Data
Feb. 24, 2006 (IN) 168/KOL/2006
Apr. 10, 2006 (EP) 06112405.3

(51) Int. Cl. G01N 21/21

(52) U.S. Cl. 356/369

(57) ABSTRACT

Method of analyzing the visual properties of a paint film comprising effect pigments illuminated by a light source, characterized in that a first polarizing filter is located between the light source and the paint film and a second polarizing filter is located between the paint film and an imaging detector, and in that the polarization axis of at least one of the polarizers is moved between an orientation substantially at right angles to the orientation of the polarization axis of the other polarizer and an orientation in which the angle between the two polarization axes is smaller.

The present invention relates to a method for analyzing the visual properties of a paint film comprising effect pigments illuminated by a light source. Paint films with effect pigments, such as metallic pigments, pearlescents, interference or multi-colour pigments, show not only colour and gloss but also various other types of visual effects, often referred to as texture. Texture includes phenomena such as coarseness, glints, micro-brilliance, cloudiness, mottle, speckle or glitter. In the following, texture is defined as the visible surface structure in the plane of the paint film depending on the size and organization of small constituent parts of a material. In this context, texture does not include roughness of the paint film but only the visual irregularities and inhomogeneities in the plane of the paint film. The relationship between colour and texture is discussed in the article “Separating Color and Pattern Information for Color Texture Discrimination”, by Mäenpää et al., Proceedings of the 26^{th} International Conference on Pattern Recognition, 2002.

Generally, structures smaller than the resolution of the human eye contribute to “colour”, whereas larger structures generally also contribute to “texture”. However, particles which are not directly observable as such also can contribute to the visual texture of a paint film, Dis-orienters are an example of such particles. Effect pigments generally are flakes tending to take a horizontal orientation in a cured film. To prevent this, and to obtain more variation in flake orientation, use is made of spherical particles, referred to as dis-orienters. Using dis-orienters in a metallic paint will result in more glitter, depending on the observation angle.

Analysis of visual properties such as colour and texture can be used in a quality control process, but also in a process for formulating a repair paint which must visually match an original paint, for instance in the field of car repair. WO 01/25737 discloses a method of imaging paint films with effect pigments using a digital imaging device. To obtain pure colorimetric spectral data in combination with separate texture data, use can be made of a combination of a digital camera imaging texture and a spectrophotometer or tri-stimulus meter measuring the spectral reflectance and tri-stimulus values, respectively,

The object of the invention is to provide a method for analyzing the visual properties of a paint film which allows switching between pure calorimetric analysis, without interference of texture effects, and texture analysis without the need to have more than one detecting device.

The object of the invention is achieved by a method for analyzing the visual properties of a paint film comprising effect pigments illuminated by a light source, a first polarizing filter being located between the light source and the paint film and a second polarizing filter being located between the paint film and an imaging detector, such that the polarization axis of one or both polarizers is moved between an orientation substantially at right angles to the orientation of the polarization axis of the other polarizer, i.e. a position wherein the polarization axes of the two polarizing fitters are substantially perpendicular, and an orientation in which the angle between the two polarization axes is smaller. Light from the light source is polarized by the first polarizer and subsequently reflected by the paint film. The light is mainly reflected/scattered by the pigments in the paint film. Whereas the effect pigments reflect the polarized light substantially with the same polarization, the other pigments, often referred to as solid pigments, scatter the light in a randomly polarized state. If the polarization axis of the second polarizer is substantially at right angles to the polarization axis of the first polarizer, the second polarizer will block all light except the randomly polarized light scattered by the solid pigments. As a result, specular effects, such as gloss, glints, glitters, and the like are filtered out. When this condition is met, the polarization axes are considered to be substantially at right angles, even if the actual angle of the two polarization axes deviates a few degrees from a 90 degree angle. If the orientation of the polarization axis of the second polarizer is changed to one in which the angle between the two polarization axes is reduced, then these specular effects turn back into the image detected by the observer. The smaller the angle between the two polarization axes, the stronger the observed specular effects. If both polarization axes are substantially parallel, or co-planar, then the specular effects are at their maximum. If the angle is small, for instance less than 5 degrees, gloss effects of the paint film are still blocked, but glints and glitter effects of the effect pigments remain visible. Effectively, this crossed polarization technique using two polarizers can optically suppress texture from colour in effect coatings.

U.S. Pat. No. 5,003,500 discloses a method for analyzing the colour of a paint film using a first polarizing filter located between the light source and the paint film and a second polarizing filter located between the paint film and a spectrophotometer. The polarizing filters are used to block gloss effects, so that pure colorimetric data is obtained. Effect paints and the problem of how to suppress texture from an effect coating are not discussed.

The observer or detector can be a human observer, a camera, or the like. If image analysis software is to be used, a digital imaging device, such as a digital video or photo camera, may advantageously be used. Alternatively, an analogous camera can be used in combination with a digitizer to digitize the obtained image. An optical power detector scanning the light intensity at particular single points of the sample can also be used.

Image analysis software can be used to analyze texture. To this end parametrized calculational texture models can be used, such as for instance disclosed in US 2001/10036309. Examples of suitable image processing software include Optimas® and Image ProPlus, both commercially available from Media Cybernetics, MacScope®, available from Mitani Corporation, or Matlab®, available from The MathWorks Inc.

The light source can be a directional light source. Alternatively, it can be a light source for diffused light. The light source can be natural daylight or it can be artificial light, such as laser, CIE standard light D65 or source F, or light from light emitting diodes (LEDs).

Optionally, the light may pass through an optical fibre arranged in advance of the polarizer or beyond.

Suitable polarizers are for example Polaroid films, such as described in Polarization prisms, such as Glan-Thomson prisms, or any other linear polarizing filters.

The method according to the invention can be implemented in the practice of automobile repair paints, where the visual properties of the repair paint should match not only the colour but also the metallic or pearlescent effect of the original, factory-applied paint. However, the method can also be applied in quality control processes to detect scratches or defects, e.g., on coated surfaces. Detection of defects can even take place in the specular angle.

The invention is further illustrated by the accompanying figures.

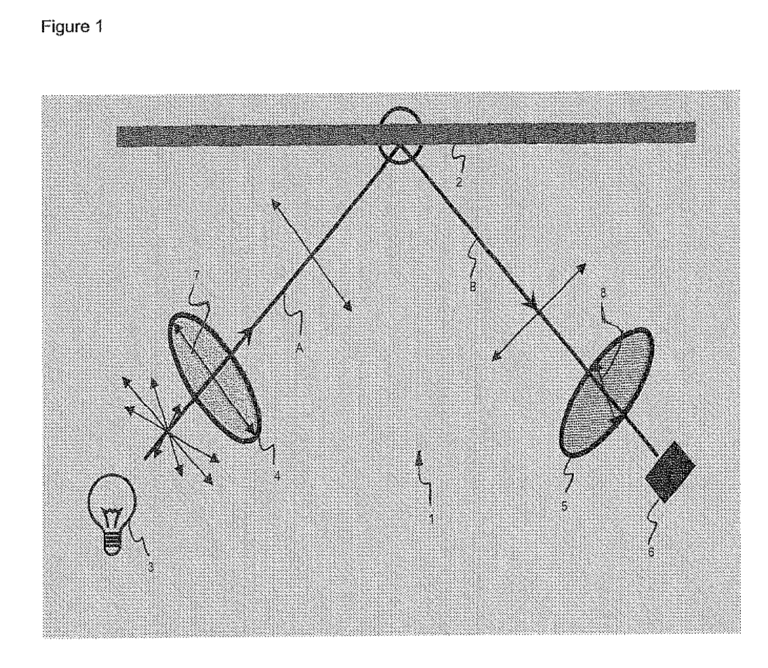

FIG. 1 shows an arrangement suitable for use according to the invention.

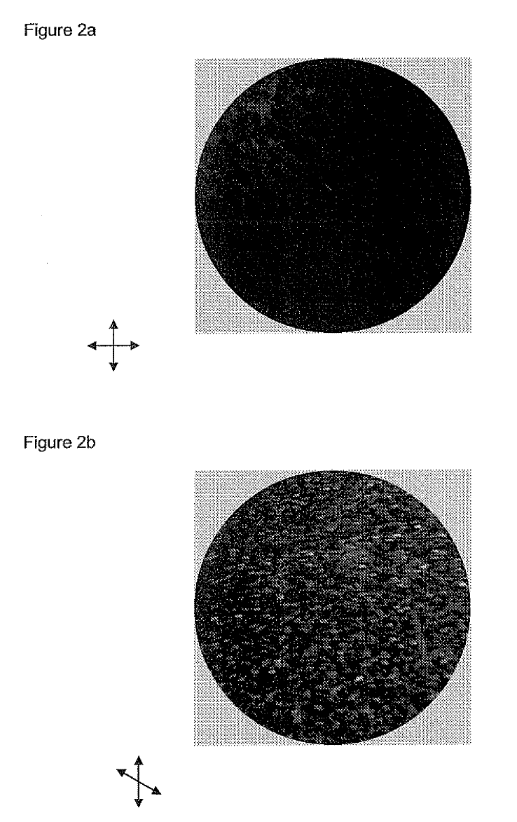

FIGS. 2a-b show the images observed at different orientations of the polarization axis of the second polarizer of a paint film with metallic pigments.

FIG. 1 shows an embodiment of an arrangement 1 suitable for the method according to the present invention for analyzing the visual properties of a paint film 2 comprising effect pigments. The arrangement 1 includes a light source 3, a sample holder to hold the panel with the paint film (not shown), a first polarizing filter 4 located between the light source 3 and the paint film 2, and a second polarizing filter or analyzer 5 located between the paint film 2 and a digital camera 6. In the drawing, line A indicates the illumination direction, while line B indicates the observation direction given by the optical axis of the camera 6. In the arrangement shown in FIG. 1, the angle between the observation direction and the substrate coincides with the specular angle or gloss angle, although this is not necessary. The first polarizer 4 has a polarization axis 7 within the plane defined by the illumination direction and the observation direction. The polarization axis 8 of the second polarizer 5 is movable between an orientation substantially at right angles to the orientation of the polarization axis 7 of the first polarizer 4 and an orientation in which the angle between the two polarization axes 7, 8 is smaller or even co-planar.

The light source 3 emits non-polarized light. Passing the polarizer 4, the light is polarized. When the light hits the paint film, colour pigments reflect the light in a de-polarized way, while the effect pigments reflect the light with the same polarization. The part of the light which is reflected in the direction of the camera 6 passes the polarization filter 5 before it arrives at the camera 6. The non-polarized light, reflected by the colour pigments, passes the polarization filter 5. If the polarization axis 8 of the polarizer 5 is at right angles to the polarization axis of the first polarizer 4, then the second polarizer 5 blocks the polarized light reflected by the effect pigments. Under this condition, an image of the paint film observed through the second polarizer 5 appears as a solid paint film surface without any texture effect. The smaller the angle between the polarization axes of the two polarizers, the less the extent to which the polarized light is blocked. If the axes of both polarizers are in the same plane, all reflected light, polarized and non-polarized, passes the second polarizer and is observed by the camera 6. If the angle between the two polarization axes is only small, for instance less than 5 degrees, gloss effects are still filtered out to a great extent, but specular effects from the effect pigments can still be observed.

Optionally, the sample holder may be made tiltable over one or more tilting axes to examine effects of the optical geometry.

In one embodiment, the polarization axis 7 of the first polarizer 4 is substantially coplanar with the illumination direction A and the observation direction B.

In FIGS. 2a and b, a panel painted with a metallic paint is shown. Both images are taken at the same observation angle but not at the same gloss or specular angle. In the images, the arrows show the mutual alignment of the polarization axes of both polarizers. In FIG. 2a, the polarization axis of the first polarizer was perpendicular to the axis of the second polarizer. As a result, an image of the paint film as a solid colour without texture effects is observed. In FIG. 2b the polarization axis of the first polarizer was at an angle of less than 5 degrees to the axis of the second polarizer. In this picture, the texture information, including glints and glitters, is observed by the camera together with the colour information. If the images are taken at the gloss or specular angle, then the image in FIG. 2a looks the same and in FIG. 2b the same texture and colour information is available together with a small gloss component.

1. A method of analyzing the visual properties of a paint film comprising effect pigments, the method comprising:
illuminating the paint film by a light source,
locating a first polarizing filter between the light source and the paint film, and locating a second polarizing filter between the paint film and an imaging detector, and
moving at least one of the polarization axis of the first polarizing filter and the polarization axis of the second polarizing filter between an orientation substantially at right angles to the orientation of the polarization axis of the other polarizing filter and an orientation in which the angle between the polarization axis of the first polarizing filter and the polarization axis of the second polarizing filter is smaller.

2. The method according to claim 1, wherein the angle between an observation direction of the imaging detector and the paint film coincides with the specular angle.

3. The method according to claim 1, wherein the imaging detector is a digital imaging device and/or a human observer.

4. The method according to claim 1, wherein the polarization axis of the first polarizing filter is substantially coplanar with an illumination direction and an observation direction.

5. The method according to claim 1, wherein the polarization axis of the second polarizing filter is moved between an orientation substantially at right angles to the orientation of the polarization axis of the first polarizing filter and an orientation substantially co-planar with the orientation of the polarization axis of the first filter.

6. The method according to claim 1, further comprising analyzing texture by using an image analysis software.

7. The method according to claim 1, wherein the method is implemented for matching the visual properties of an automobile repair paint with an original, factory-applied paint.

8. A method comprising analyzing the visual properties of a paint film comprising effect pigments, wherein the analyzing is done with an imaging arrangement including a light source, a sample holder, a first polarizing filter located between the light source and the sample holder, and a second polarizing filter located between the sample holder and an imaging detector, wherein at least one of the polarization axis of the first polarizing filter and the polarization axis of the second polarizing filter is movable between an orientation substantially at right angles to the orientation of the polarization axis of the other polarizing filter and an orientation in which the angle between the polarization axis of the first polarizing filter and the polarization axis of the second polarizing filter is smaller.

9. The method according to claim 2, wherein the imaging detector is a digital imaging device and/or a human observer.

10. The method according to claim 3, wherein the digital imaging device is a digital camera.

11. The method according to claim 9, wherein the digital imaging device is a digital camera.

12. The method according to claim 2, wherein the polarization axis of the first polarizing filter is substantially coplanar with an illumination direction and the observation direction.

13. The method according to claim 3, wherein the polarization axis of the first polarizing filter is substantially coplanar with an illumination direction and an observation direction.

14. The method according to claim 2, wherein the polarization axis of the second polarizing filter is moved between an orientation substantially at right angles to the orientation of the polarization axis of the first polarizing filter and an orientation substantially co-planar with the orientation of the polarization axis of the first polarizing filter.

15. The method according to claim 3, wherein the polarization axis of the second polarizing filter is moved between an orientation substantially at right angles to the orientation of the polarization axis of the first polarizing filter and an orientation substantially co-planar with the orientation of the polarization axis of the first polarizing filter.

16. The method according to claim 4, wherein the polarization axis of the second polarizing filter is moved between an orientation substantially at right angles to the orientation of the polarization axis of the first polarizing filter and an orientation substantially co-planar with the orientation of the polarization axis of the first polarizing filter.

17. The method according to claim 2, further comprising analyzing texture by using an image analysis software.

18. The method according to claim 4, further comprising analyzing texture by using an image analysis software.

19. The method according to claim 5, further comprising analyzing texture by using an image analysis software.

20. The method according to claim 1, wherein the method is implemented for matching the visual properties of an automobile repair paint with an original, factory-applied paint.
